(19) United States
(12) Patent Application Publication
(10) Pub. No.: US 2011/0004562 A1
(43) Pub. Date: Jan. 6, 2011

(54) Method and System for Delivering Shipping Information

(76) Inventors: Jerry Hennessy, Paradise Valley, AZ (US); Erin Heuchlow, Laveen, AZ (US)

Correspondence Address: PATENT GROUP;MACDONALD, ILLIG, JONES & BRITTON LLP, 100 STATE STREET, SUITE 700, ERIE, PA, 16507-1459, US

(21) Appl. No.: 12/809,492

(22) PCT Filed: Dec. 12, 2008
(86) PCT No.: PCT/EP08/10574

§ 371 Date: Sep. 10, 2010

Related U.S. Application Data
(60) Provisional application No. 61/015,468, filed on Dec. 20, 2007.

(30) Foreign Application Priority Data
Dec. 19, 2007 (DE) 10 2007 061 695.5

(51) Int. Cl. G06Q 10/00; H04M 11/10; H04W 4/12

(52) U.S. Cl. 705/333; 455/413; 455/466

(57) ABSTRACT

The invention relates generally to logistics systems and methods. In particular, the present invention relates to a method and a corresponding computer system for delivering shipping information, comprising—automatically detecting that a user at a front-end of a telephone channel is eligible to receive information about a shipment still in transit to the user; —obtaining user information by an IVR (Interactive Voice Response) interface; —obtaining shipping information associated with said shipment; —based on said shipping information automatically generating a telephony message incorporating the current status of the shipment and sending it to the user.

### FIELD OF THE INVENTION

The invention relates generally to logistics systems and methods. In particular, the present invention relates to a method and a computer system for delivering shipping information about the current status of a shipment of goods.

### BACKGROUND

Logistics systems manage the shipments of goods. They comprise a variety of modules integrated with each other to perform various functionalities. For example, they may comprise a purchasing module evaluating proposals for respective shipments of goods and awarding contracts for the shipments. There may be optimization modules analyzing the proposals and informing the purchasing module if an opportunity exists for at least some of the shipments to be consolidated, in which case at least one contract awarded by the purchasing module is for a consolidated group of the shipments. Administration modules may maintain information relating to the status of proposals received and contracts awarded by the purchasing module. A scheduling module may schedule shipments according to the awarded contracts. On base of a shipment management module it is also possible to track the status of shipments awarded by the purchasing module and scheduled by said scheduling module. A financial module may authorize payments according to the status of shipments tracked by the shipment management module which are for example passed between first and second asynchronous clock domains.

A method and a system for updating status information about shipments via email are known from U.S. Pat. No. 6,047,264. This document discloses a method for automatically updating the status of a user's orders and shipments via email without using a human attendant by creating and sending email messages.

A web-based electronic shipment system is described in U.S. Pat. No. 6,220,509. There is disclosed a parcel trace system which provides a browser design adapted for one shipping provider and a plurality of users and another browser design adapted for one user and a plurality of shipping providers.

The shipping of mail and parcel items can typically be described in terms of three primary transport legs. In the first leg, a shipping item, e.g. an envelope, a package, etc., is taken from an initial sender's address to a local collection centre of a shipping service provider. In the second leg, the item is transported from the local collection centre to a delivery centre. In the third leg, the item is transported from the delivery centre to its final destination address.

In general, it is possible that multiple shipping service providers may be employed over the three primary transport legs set forth above. For example, a local courier might provide transportation of a package from a business to a national or regional carrier's drop location, thus handling the first leg. The national or regional carrier might then provide service over the second leg, transporting the package from the drop location, possibly through one or more intermediate hubs, to a delivery centre near the destination address. A third shipping entity may then provide delivery over the last leg.

It is also possible that a single shipping service provider may provide service over two or more legs. For example, a local courier might provide service over the first leg by transporting a package from a business or residence to a local post office, where another shipping service provider provides service over the second and third legs. There are shipping entities which provide door to door service on their own.

Some shipping service providers have an established infrastructure for carrying out the second and third legs of the shipping process. These companies are well equipped for sorting, routing and transporting mail and parcel items once the items are received at a collection warehouse.

As a consequence of the inhomogeneity of the transport process, especially with respect to the number of service providers involved in delivery of a single shipment, the accurate estimation of the delivery of a shipment at the time when the shipment is sent is quite difficult. On the other hand, the customer/recipient of the shipment would like to be informed about the time when to expect the delivery of the shipment. Therefore, there is a need for an efficient solution to facilitate and improve the process of delivering shipping information for the recipient.

### SUMMARY OF THE INVENTION

In the following description, the term shipping refers to the transport of any mail or goods using any available transportation means. Shipping typically involves one or more legs of transportation from an origin location to a destination. Terms referring to mail, package, parcel or shipment are interchangeably used to refer to any and all shipped items.

A method for facilitating shipping according to the present invention comprises the following steps:
automatically detecting that a user at a front-end of a telephone channel wants to receive information about a shipment still in transit to the user; The method of detection is via the waybill number, not by customer: if not yet delivered, then offer the notification option.
obtaining user information by an IVR (Interactive Voice Response) interface;
obtaining shipping information associated with said shipment;
based on said shipping information automatically generating a telephony or SMS/text message incorporating the current status of the shipment and sending it to the user.

A user according to the current invention is understood as the recipient of a shipment. One of the main features of this method is that user information is obtained by an Interactive Voice Response (IVR) interface. Such IVR systems are commonly known from bank hot-lines for example. The user is asked questions by an electronic voice to which the user can answer by voice or by entering predetermined numbers on the keyboard of his telephone.

With respect to the current invention, it is preferred that the user's answer is given vocally, because this type of answering is more comfortable for the user. If the answer cannot be analyzed correctly by the IVR system, the question is repeated and the user is asked to answer using the keyboard of his phone. This can be realized for example by pressing the number “1” for the answer “yes” and if the answer shall be “no”, the number “2” has to be pressed.

If a user calls a given phone number of a delivery service, the user is connected to such an automatic IVR system and the application determines by the shipment number whether to make the offer of providing the service to the customer based on that shipments not yet delivered status. Concerning the current invention, it is also possible that the phone number the user is calling is reserved for such status information only. In such a case, this first user interaction step is not necessary.

The user is then asked about an identification of the shipment that he wants to get status information for. This is usually a code that has to be communicated from the user to the computer system.

It is possible to use different implementations of the code.

In one implementation if the code contains not only numbers but also letters and the code shall be entered over the keyboard of the phone, this can be done by using the keyboard the same way as for writing SMS, i.e. the letter “C” for example corresponds to three times pressing the number “1”, the letter “N” corresponds to pressing the “6” twice and so forth.

In another implementation of the invention only digits are spoken or input in waybill capture at present.

In the context of the current invention, the term “user information” is a set of user relevant data. This is the user's phone number, to which the telephony message shall be sent. Other user information is whether the user prefers to receive a spoken telephony message or a text message like SMS or MMS. (here and throughout, MMS is not a current capability) The user information is obtained by an Interactive Voice Response (IVR)-system in which the user is asked for each piece of relevant user information. The information is then given vocally by the user or can be entered using the keyboard of the telephone. Because vocally answering is more comfortable for the user, it is preferred in the context of the current invention that the user can answer vocally, first. In case, the user's answer cannot be identified correctly, the user is prompted to enter his answer by the use of the telephone keyboard.

In one embodiment of the invention this feature is tied specifically to pickup address locations. These locations are associated with unique phone numbers and are presented. In tracking systems, there is little to no relationship between customer information by account and waybill number so these features are not exploited. In this case Waybills/systems have consignee and shipper info usually, but not account numbers or account holder information.

According to a preferred embodiment of the invention an link between waybill and account/phone number exists and provides value.

Another important point in tracking is that very often the tracking party has no association to DHL by relationship/account. They are tracking a shipment from a vendor and are not a customer otherwise, for instance.

In general, the IVR process may involve a step in which the information given by the user is repeated by the system and the user is asked to confirm that this is correct.

In case the user's telephone number is transferred when the telephone connection with the system is established, for example by CLIP (Calling Line Identification Presentation), the user can be asked by the system, whether the phone from which he is calling shall be the same phone, he wants to receive the telephony messages on. The user can also choose a different phone number.

Another user information is which mobile phone provider the user is customer of. The computer system according to the current invention may offer a certain number of mobile phone providers that can be used in connection with SMS or MMS-type telephony messages by IVR. In case the user is customer of a provider which is not supported by the computer system according to the current invention, the user may be informed by IVR that SMS or MMS is not possible with that provider and asked whether he wants to receive the shipment status report information by voice instead. The automated calls can be listened to real time and are not necessarily left as a voicemail, as an integration of voicemail is included in the scope of the current invention.

According to a further embodiment of the current invention, the user information is stored for the later use. This is done in a database of a computer system for example. This computer system is preferably the same which is also used for carrying out the IVR dialogue. In this case, the user might be asked in a first step of the IVR dialogue whether he wants to be informed the same way as in earlier cases, i.e. by the same type of telephony message under the identical phone number. This shortens the IVR dialogue and increases comfort for the user as he does not have to enter his set of user information for each new shipment again.

Concerning possible receiving tools for the telephony message, the current invention is not restricted. It is possible to send the telephony messages to all type of hardware that can be addressed by telephony messages, usually to those that have a phone number. This can be a mobile phone, a landline phone or a pager for example. Mobile phones and pagers are usually carried the whole day by the user that is why these systems are preferred.

An advantage of the current invention is that a substantially greater number of people are connected to a telephony system, either mobile or landline phone, whereas only a smaller number have access to the internet. So the current invention offers a new information system that is capable of reaching a broader range of users. An additional advantage of the current invention is that people usually have the whole day access to a telephone, especially to a mobile phone, but not the whole day to a computer system. Because of this, the user is able to get the tracking information immediately, because he does not have to lock on a computer system. This enhances flexibility for the user in so far that he can arrange to be at home when the shipment arrives or if the shipment is sent to a package station the user could go there directly, for example on the way home from work, and pick up the shipment. In a preferred embodiment of the current method, the telephony message is a spoken telephony message, preferably using speech automation, a message of the short message service type (SMS) or a multimedia messaging service type (MMS) message. Modern landline phones are also capable of receiving short messages (SMS) or even (MMS) that is why this preferred embodiment can also be used with landline phones. This gives the user the opportunity to adopt the message to the preferred type.

The choice between SMS and MMS can be made by the user or preferably by the operator of the invented method or system.

According to a preferred embodiment of the current invention, said telephony message is sent each time the status of the shipment has changed. A status change can be that the shipment which was at first stored in a warehouse was handed over to a delivery service. Another change of status can also be that the shipment has been brought to its destination. This can be a delivery to the user's home address or to a station where the user can pick up his shipment. So it is further preferred to send a telephony message when said shipment is delivered especially when it is delivered to a package station. As a consequence, the user does not have to look several times actively for the status of his/her shipping as it is necessary with internet based procedures, but gets automatically informed if there is a status change of the shipping. This makes the current process much more comfortable for the user. It is also possible to combine the information about the status of the shipment with other types of information or advertisement, especially in combination with SMS or MMS messages.

In a further preferred embodiment of the method, said telephony message further comprises the expected time of delivery of said shipment.

According to a further embodiment of the current invention, the method comprises the further step of accessing pre-existing account information associated with said user. As mentioned before, user information can be stored for the later use. If a user calls and is identified, either by his phone number or by the code of the shipment he wants to track, he is asked whether he wishes to receive actual status information of his shipment as in earlier cases.

A further embodiment of the current invention is a computer system for delivering shipping information, comprising
means for automatically detecting that a user at a front-end of a telephone channel wants to receive information about a shipment still in transit to that user;
means for obtaining user information by an IVR (Interactive Voice Response) interface;
means for obtaining shipping information associated with said shipment;
means for automatically generating a telephony message incorporating the current status of the shipment and for sending said telephony message to the user.

The computer system comprises means for automatically detecting that a user at a front-end of a telephone channel wants to receive information about a shipment still in transit to that user. This can be realized by electronically identifying the user by his telephone number (CLIP) and check for pre-existing account information associated with said user by the computer. Another possibility is the use of an IVR dialogue to get this information actively from the user.

In a next step, the computer system may check whether there are one or more a shipment is still in transit to for that user. For this procedure, the computer system of the current invention is connected to a database in which the information about shipments is stored. The connection can be realized by an internet connection or via LAN or wireless LAN (Local Area Network). Another possibility is that the computer system of the current invention is part of the computer system that manages the database concerning the shipments; in this case the information can be received from the system itself.

If there is a shipment still in transit to the calling user, the described network connection is also used to obtain the shipping information associated with the shipment, i.e. the actual status of that shipment.

A further part of the computer system according to the invention is that it comprises means for obtaining user information by an IVR (Interactive Voice Response) interface. That is a commonly known IVR itself and data storage means and processing units (CPU) that are capable to compute the questions asked in the IVR dialogue and process the answers given by the customer, which can be given verbally or by the use of the telephone keyboard. The processing of the answers leads to user related information like the opportunity to enter/say the user's preferred notification phone number and his choice of how to be informed, i.e. via voice mail or SMS. This user information is usually stored for later use (the contact info is stored by waybill number. It is as well possible to delete the user information after the notification has taken place. Alternatively it is possible to store the user information after the notification has taken place.

The first alternative has the advantage, that storage place is reduced. The second alternative increases a possibility of process checks and verifying the correctness of processes.

As storage of the user information (contact info) also allows later reuse.

However, it is especially preferred, that the user information is utilized exclusive to the one waybill being notified.

The computer system comprises also means for automatically generating a telephony message which incorporates the current status of the shipment and for sending said telephony message to the user. This is realized by a communication module. This communication module may provide tools that allow the system to communicate with multiple devices using multiple message formats, automatically generated voice messages, SMS, MMS, pager messages etc. that are streamed through multiple communication means. To realize this, the computer connects to the above described database in which the shipment information is stored and checks the status of the shipment which is in transit to the calling user. The status is transformed into a telephony message, i.e. a voice mail, SMS or MMS and sent to the user by a telephone interface. Such telephone interfaces are known to a person skilled in the art and provide means to introduce the above described telephony messages into a telephone line.

According to a preferred embodiment of the current invention, the computer system comprises means for automatically generating a telephony message in form of a spoken telephony message, preferably using speech automation, a message of the short message service type (SMS) or multimedia message service (MMS).

In a further preferred embodiment of the current invention, the computer system comprises means for calculating an expected time of delivery of said shipment. These means calculate the expected delivery date or time for example using statistical data of how long a shipment of certain size takes from the starting point to the destination. Week-ends and times in which delivery might take longer, like short before Christmas, might also be taken into consideration for the calculation.

The invention described herein is set forth in terms of methods and computer systems implementing those methods. It will be apparent, however, to one with ordinary skill in the art that the invention may be implemented as computer software, e.g. computer program code, capable of being stored in a computer memory and executed by a microprocessor.

Each component or module of the computer system may be implemented as part of a larger infrastructure, e.g. within an application server, or as one or more plug-in programs, applets, dynamically loaded libraries, or any other configuration that allows programs to run on one or more computers in order to provide shipping information management. The programs may be embedded within, or interfaced with third party applications. Although described in modular terms for purposes of illustration, embodiments of the invention need not be limited to modular implementations. The functionality described herein may be implemented in software and/or hardware as a single process or as a combination of multiple processes and/or applications.

While example embodiments are described herein, the various aspects of the present invention may be used with various types of computer systems, generally including all system designs which link together disparate processing units such as computers, servers, peripherals, storage devices, and devices for data communications. Examples of such computer systems may include a local area network (LAN), a wide area network (WAN), a metropolitan area network (MAN), and a global area network (GAN). The computer system may be centralized in one or relatively few locations or may be distributed throughout a relatively large number of locations.

The computer system according to the invention may include a plurality of component modules. These software component modules may be either commercially available off-the-shelf software, customized software or independently developed software. If they are robust and capable of integration with other software components to accomplish the workflows described below, then they can be utilized in the computer system.

Other features of the invention may be apparent to those skilled in the art from the detailed description of the example embodiments and claims when read in connection with the accompanying drawing. While the foregoing and following written and illustrated disclosure focuses on disclosing example embodiments of the invention, it should be understood that the same is by way of illustration and example only, is not to be taken by way of limitation and may be modified in learned practice of the invention. While the foregoing has described what are considered to be example embodiments of the invention, it is understood that various modifications may be made therein and that the invention may be implemented in various forms. The invention is defined by the claims and their full scope of equivalents.

### BRIEF DESCRIPTION OF THE DRAWING

FIG. 1 is a flowchart illustrating the invented method.

FIG. 1 describes in detail, how the invented method is applied to lead a calling user, who wishes to get status information about his current shipment he is expecting, through several Dialog Modules (DM). Each DM is supposed to get a piece of user information to enable the system to finally send status information about the shipment still in transit to that calling user by a telephony message. Each piece of information, like whether the user wants to be informed via voice mail or SMS, or the user's phone number, is requested by means of an IVR (Interactive Voice Response) interface.

The user enters the procedure by calling a given phone number that is known by the user as an information hot-line from which he can get information about the current status of his shipment. The user can get this phone number from the internet home page of the delivery service or by calling an information desk.

FIG. 1 shows the process about how a user is lead through the IVR dialogue if he wants to track a package. Of course, tracking a package is only an example and the displayed flow diagram can be applied also for all other types of shipments. In the following, the process is explained by a completely voice-based answer of the user.

“This implementation includes “voicemail” as well as “voice”. Both alternatives are possible? An application calls an user and the user may listen to the speech engine. The speech engine (application) tells the user about the user's shipment(s) in real time. If the user were to miss that call, the message would be deposited as a recorded voicemail message.

This can be also arranged by prompting the user to enter the answers by the use of his telephone keyboard. To do so, the user is told for example to press the number “1” if the answer shall be “Yes” and to press the number “2” if the answer shall be “No”.

Certainly, the process can also be managed in such a way that the user is prompted first to answer vocally and only if the IVR system cannot analyze this given answer, the user is asked the same question again, but prompted to enter the answer via keyboard of his phone.

In a first step, the user is asked by the IVR whether he wants to track a package. If the user answers with “Yes”, the IVR dialogue continues; in case the user answers with “No”, the IVR dialogue is terminated.

In case the user's answer was “Yes”, he is then asked about the number code of the shipment, he wants to get status information for. The user answers the question by telling the number code of his shipment. The process proceeds to Dialogue Module DM (4000).

In the next step, Dialogue Module DM (4000), the user is asked whether he wants to be informed by a voice mail, in which case he shall answer by saying for example “phone” and the process is continued under DM (4002) or if he prefers to be informed via SMS in which case his answer shall be “SMS” and the process is continued under DM (4001).

In Dialogue Module (4001), the user is asked by the IVR dialogue about the service provider of his cell phone. The user answers by telling his “provider” and the system checks next, whether this provider is an eligible provider. In case the provider is an eligible provider, the process continues with DM (4002) in case the provider is not an eligible provider, the process continues with DM (4003).

Dialogue Module (4002) is supposed to get the user's phone number. The user tells the phone number to which the tracking information shall be sent and the process continues to DM (4004) in which the user is informed that he is registered for delivery notification under the phone number he stated. DM (4002) can also include a step, in which the system vocally repeats the phone number as it is analyzed by the system and asking the user to confirm whether this phone number is correct or not. If the number is not correct, the user is asked to tell his phone number again. If the number is correct, the system proceeds to DM (4004).

Dialogue module (4003) is run in case the user is not customer of an eligible provider. In this case, the user is asked via IVR, whether he would like to be called instead and thus receive the tracking information by a voice mail. If the user answers with “Yes” the process is continued under DM (4002). In case the user's answer is “No”, the process proceeds to DM (4005).

Dialogue Module (4005) asks the user if he would like to track another package or whether he would like to go back to the main menu to start over the dialogue.

### EXAMPLE

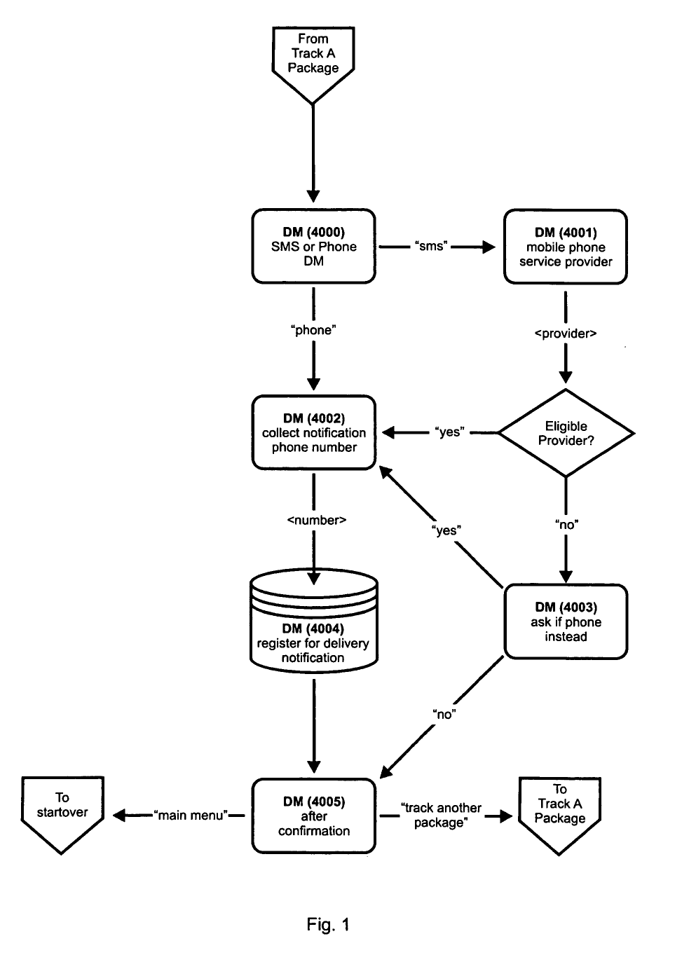

The current invention is described in more detail in the following example. The example illustrates of how the method according to the Dialogue Modules DM (4000), (4001), (4002) and (4003) is realized according to the flow chart displayed in FIG. 1, especially how the Interactive Voice Response dialogue is carried out. The numbers mentioned below refer to the Dialogue Module numbers in FIG. 1.

DM (4000) - SMSOrPhone - Dialogue Module
CustomContext DialogModule ™

[symbol]

In this module, callers choose between notification by phone or SMS.
Entering from
Track a package
Prompts

| Type | Condition | Name | Wording |
|---|---|---|---|
| Initial | Always | 4000_ini | How would you like us to contact you when your package has been |
| | | | delivered - by “a phone call” or by “a text message to your cell phone”? |
| | | | (Note: contrastive emphasis must be reinforced here for this to work.) |
| No-match 1 | Always | 4000_nm1 | Please say ‘phone call’ or ‘text message’. If you're not sure which one to |
| | | | choose, say ‘more information’. |
| No-match 2 | Always | 4000_nm2 | If you'd like to receive confirmation by phone, press 1. If you'd like to |
| | | | receive your confirmation message by text message, press 2. |
| No-input 1 | Always | 4000_ni1 | Please say ‘phone call’ or ‘text message’. If you're not sure which one to |
| | | | choose, say ‘more information’. |
| No-input 2 | Always | 4000_ni2 | If you'd like to receive confirmation by phone, press 1. If you'd like to |
| | | | receive your confirmation message by text message, press 2. |
| Help | Always | 4000_hlp | We can get you a confirmation message when that package has been |
| | | | delivered, but we need to know whether you want us to *call* you or |
| | | | whether you'd prefer an SMS text message on your cell phone. Please say |
| | | | ‘phone call’ or ‘text message’ now. |
| Exit, success | Caller said Phone call | 4000_exit1 | Okay, a phone call. |
| | Caller said Text | 4000_exit2 | Okay, a text message on your cell phone. |
| | message | | |

| Option | Vocabulary | DTMF | Condition | Action | Confirm. |
|---|---|---|---|---|---|
| Phone call | Phone, | 1 | Always | Set type as Phone | Never |
| | Phone call, a | | | Go to: 4002-CollectPhoneNotification-DM | |
| | phone call, by | | | | |
| | phone call, by | | | | |
| | phone | | | | |
| | Call me, | | | | |
| | etc | | | | |
| Text | Text message, | 2 | Always | Go to: 4001-WhichServiceProvider-DM | Never |
| message | “text message to | | | | |
| | my cellphone”, “text | | | | |
| | message to a cell | | | | |
| | phone”, “text | | | | |
| | message to a cell | | | | |
| | phone”, “by text | | | | |
| | message”, “text | | | | |
| | message to your | | | | |
| | cell phone” | | | | |
| | Text, | | | | |
| | SMS | | | | |

Confirmation prompts

| Option | Name | Wording |
|---|---|---|
| N/A | | |

DialogModule parameters

| Parameter | Value |
|---|---|
| Timeout after end of speech | 1,000 ms |
| Timeout before start of speech | 5,000 ms |
| Barge-in | Barge-in ON over all prompts |

Event logging
State Event Logging: (prior to entry)
EVNT = State | NAME = This State Name

DM 4001 - WhichServiceProvider - Dialogue
CustomContext DialogModule ™

[symbol]

In this dialog module, callers who want delivery notification by text
message are asked for the name of their cell phone provider.
DHL requested offering an agent in help/error prompts here.
Entering from
4000-SMSOrPhone-DM
Prompts

| Type | Condition | Name | Wording |
|---|---|---|---|
| Initial | Always | 4001_ini | What's the name of the company that provides your cell phone service? |
| No-match 1 | Always | 4001_nm1 | Please say the name of your cell phone provider again now. |
| No-match 2 | Always | 4001_nm2 | Please tell me the name of the company that provides your cell phone |
| | | | service, or if you don't know it press 2. |
| No-input 1 | Always | 4001_ni1 | Please say the name of your cell phone provider. |
| No-input 2 | Always | 4001_ni2 | Please tell me the name of the company that provides your cell phone |
| | | | service, or if you don't know it press 2. |
| Help | Always | 4001_hlp | In order to send you a *text* message with delivery confirmation, I need the |
| | | | name of the company that provides your cell phone service. Please tell me |
| | | | the name of your cell phone company, or if you don't have one, say ‘I don't |
| | | | have a cell phone. |
| Exit, success | Caller said Don't | 4001_exit | Okay. |
| | Know | | |
| Exit, failure | Caller has max error | 4001_exit2 | I'm sorry I'm having so much trouble. |

| Option | Vocabulary | DTMF | Condition | Action | Confirm. |
|---|---|---|---|---|---|
| Provider | Alltel, Cingular, | (none) | Always | Set type as SMS | If necessary |
| | Nextel, Sprint, | | | Go to: 4002-CollectPhoneNotification-DM | |
| | SunCom, T-mobile, | | | | |
| | VoiceStream, | | | | |
| | Verizon, | | | | |
| | BellMobility, | | | | |
| | Blackfoot, Clearnet, | | | | |
| | GoAmerica, | | | | |
| | RogersATT, | | | | |
| | RuralCellular, | | | | |
| | Telus, USCellular, | | | | |
| | etc. | | | | |
| Don't Know | I don't know, | 2 | Always | Set reason as NoCell | Never |
| | I don't have a cell | | | Go to: 4003-AskPhoneInsteadYesNo-DM | |
| | phone | | | | |

Confirmation prompts

| Option | | Name | Wording | Result |
|---|---|---|---|---|
| Provider | Alltel | Alltel | That was Alltel - right? | |
| | Cingular | Cingular | That was Cingular - right? | |
| | Nextel | Nextel | That was Nextel - right? | |
| | Sprint | Sprint | That was Sprint - right? | |
| | SunCom | SunCom | That was SunCom - right? | |
| | T-mobile | TMobile | That was T-Mobile - right? | |
| | Voicestream | VoiceStream | That was Voice Stream - right? | |
| | Verizon | Verizon | That was Verizon - right? | |
| | Bell Mobility | Bell Mobility | That was Bell Mobility - right? | |
| | Blackfoot | Blackfoot | That was Blackfoot - right? | |
| | Clearnet | Clearnet | That was Clearnet - right? | |
| | GoAmerica | GoAmerica | That was GoAmerica - right? | |
| | RogersATT | RogersATT | That was RogersATT - right? | |
| | RuralCellular | RuralCellular | That was RuralCellular - right? | |
| | Telus | Telus | That was Telus - right? | |
| | Cricket | Cricket | That was Cricket - right? | |
| | USCellular | USCellular | That was USCellular - right? | |
| | (not | 4001_conf1 | That was . . . | |
| | pre- | TTS | [Provider] | |
| | recorded) | 4001_conf2 | . . . right? | |
| | | Example: | That was . . . Cingular . . . right? | |

DialogModule parameters

| Parameter | Value |
|---|---|
| Timeout after end of speech | 1,000 ms |
| Timeout before start of speech | 5,000 ms |
| Barge-in | Barge-in ON over all prompts |

Event logging
State Event Logging: (prior to entry)
EVNT = State | NAME = This State Name

DM (4002) - CollectPhoneNotification - Dialogue Module
Phone DialogModule ™

[symbol]

In this state, callers give the phone number where they want to get
the delivery notification message.
Entering from
4000-SMSOrPhone-DM
4001-WhichServiceProvider-DM
4003-AskPhoneInsteadYesNo-DM
Prompts

| Type | Condition | Name | Wording |
|---|---|---|---|
| Initial | If type is Phone | 4002_ini | Starting with the area code, tell me the phone number where you want us to |
| | | | call you. |
| | Else | 4002_ini2 | Starting with the area code, tell me the cell phone number where you want |
| | | | us to send your delivery confirmation text message. |
| No-match 1 | Always | 4002_nm1 | Please say or enter the phone number again now. |
| No-match 2 | If type is Phone | 4002_nm2 | Tell me the phone number where you want us to call you when the |
| | | | shipment has arrived, or enter the number on your telephone keypad. |
| | Else | 4002_nm22 | Tell me the phone number where you want us to send you an SMS text |
| | | | message when the shipment has arrived, or enter the number on your |
| | | | telephone keypad. |
| No-input 1 | Always | 4002_ni1 | Please say or enter the phone number. |
| No-input 2 | If type is Phone | 4002_ni2 | Tell me the phone number where you want us to call you when the |
| | | | shipment has arrived, or enter the number on your telephone keypad. |
| | Else | 4002_ni22 | Tell me the phone number where you want us to send you an SMS text |
| | | | message when the shipment has arrived, or enter the number on your |
| | | | telephone keypad. |
| Help | If type is Phone | 4002_hlp | We will call you when the shipment has been delivered, but we need to get |
| | | | your phone number first. Tell me the phone number again now, or enter |
| | | | the number on your telephone keypad. |
| | Else | 4002_hlp2 | We will send you an SMS text message when the shipment has been |
| | | | delivered, but we need to get your phone number first. Tell me the phone |
| | | | number again now, or enter the number on your telephone keypad. |
| Exit, success | Always | 4002_exit | Okay. |

| Option | Vocabulary | DTMF | Condition | Action | Confirm. |
|---|---|---|---|---|---|
| Phone | <phone number> | <phone | Always | Go to: 4004-RegisterForDeliveryNotification- | Always |
| | | number> | | DB | |

Confirmation prompts

| Option | Name | Wording | Result |
|---|---|---|---|
| Phone | CPR | <phone number> | $input = <phone number> nnn-nnn-nn-nn |
| | | Type: Digits | $tone = final |
| | | Example: | Four one five-three seven one-eight two-five five. Is that right? |

DialogModule parameters

| Parameter | Value |
|---|---|
| Listen for long distance (10-digit phone numbers) | Yes |
| Listen for local (7-digit phone numbers) | No |
| Listen for X11 (411, 511, 611, and 911) | No |
| Timeout after end of speech | 1,000 ms |
| Timeout before start of speech | 5,000 ms |
| Barge-in | Barge-in ON over all prompts |

Event logging
State Event Logging: (prior to entry)
EVNT = State | NAME = This State Name

DM (4003) - AskPhoneInsteadYesNo - Dialogue Module
YesNo DialogModule ™

[symbol]

In this dialog module, callers who wanted notification by SMS but who either didn't know/have a cell phone number
or whose provider was not on the eligible list are asked if they want notification by phone instead.
Entering from
4001-WhichServiceProvider-DM
Prompts

| Type | Condition | Name | Wording |
|---|---|---|---|
| Initial | Reason is ineligible | 4003_ini | I'm sorry, but right now we don't offer text messaging with that service |
| | | | provider. Can we call you instead? |
| | Else (including callers | 4003_ini2 | Can we call you when the package is delivered? |
| | who experienced a | | |
| | maxerror in 4001) | | |
| No-match 1 | Always | 4003_nm1 | Please say ‘yes’ or ‘no’: would you like us to call you when the package is |
| | | | delivered? |
| No-match 2 | Reason is ineligible | 4003_nm2 | Unfortunately we can't send you a text message when the shipment has |
| | | | been delivered, but we can give you a call instead. If you'd like us to call |
| | | | you, press 1. If not, press 2. |
| | Else | 4003_nm22 | If you'd like us to call you when the shipment is delivered, press 1. If not, |
| | | | press 2. |
| No-input 1 | Always | 4003_ni1 | Please say ‘yes’ or ‘no’: would you like us to call you when the package is |
| | | | delivered? |
| No-input 2 | Reason is ineligible | 4003_ni2 | Unfortunately we can't send you a text message when the shipment has |
| | | | been delivered, but we can give you a call instead. If you'd like us to call |
| | | | you, press 1. If not, press 2. |
| | Else | 4003_ni22 | If you'd like us to call you when the shipment is delivered, press 1. If not, |
| | | | press 2. |
| Help | Reason is ineligible | 4003_hlp | We only offer text messaging with specific phone service providers, and |
| | | | unfortunately we don't have it for yours. We can call you when the |
| | | | shipment has been delivered instead, though. If you'd like us to call you, |
| | | | say ‘yes’. If not, say ‘no’. |
| | Else | 4003_hlp2 | If you want us to call you when the shipment is delivered, say ‘yes’. If not, |
| | | | say ‘no’. |

| Option | Vocabulary | DTMF | Condition | Action | Confirm. |
|---|---|---|---|---|---|
| Yes | yes, | 1 | | | Never |
| | yes please, sure, | | | | |
| | yes you can | | | Go to: 4002-CollectPhoneNotification-DM | |
| No | no, | 2 | Always | Set flag for NoDeliveryWanted | Never |
| | no thanks, no | | | Go to: 4005-AfterConfirmation-DM | |
| | please don't, | | | | |
| | no thank you | | | | |

DialogModule parameters

| Parameter | Value |
|---|---|
| Timeout after end of speech | 500 ms |
| Timeout before start of speech | 5,000 ms |
| Barge-in | Barge-in ON over all prompts |

Event logging
State Event Logging: (prior to entry)
EVNT = State | NAME = This State Name

1. A method for delivering shipping information, comprising
automatically detecting that a user at a front-end of a telephone channel wants to receive information about a shipment still in transit to the user;
obtaining user information by an IVR (Interactive Voice Response) interface;
obtaining shipping information associated with said shipment;
automatically generating a telephony message based on said shipping information incorporating the current status of the shipment and sending it to the user.

2. The method according to claim 1,
characterized in that,
said telephony message is a spoken telephony message, preferably using speech automation, a message of the short message service (SMS) type or multimedia message service (MMS) type.

3. The method according to claim 1,
characterized in that,
said telephony message is sent to the cellular phone of said user.

4. The method according to claim 1,
characterized in that,
said user is asked to choose between spoken telephony message, a message of the short message service (SMS) type and a message of the multimedia message service (MMS) type.

5. The method according to claim 1,
characterized in that,
said telephony message is sent each time the status of the shipment has changed.

6. The method according to claim 1,
characterized in that
said telephony message further comprises the expected time of delivery of said shipment.

7. The method according to claim 1,
characterized in that,
said telephone message is sent when said shipment is delivered.

8. The method according to claim 1,
characterized in that,
the method comprises the further step of accessing pre-existing account information associated with said user.

9. A system for delivering shipping information, comprising
means for automatically detecting that a user at a front-end of a telephone channel is eligible to receive information about a shipment still in transit to that user; (If eligible, then offer).
means for obtaining user information by an IVR (Interactive Voice Response) interface;
means for obtaining shipping information associated with sais shipment;
means for automatically generating a telephony message incorporating the current status of the shipment and for sending said telephony message to the user.

10. The system according to claim 9,
characterized in that,
wherein the computer system comprises means for automatically generating a telephony message in form of a spoken telephony message, preferably using speech automation, a message of the short message service type (SMS) or multimedia message service (MMS).

11. The system according to claim 9,
characterized in that,
wherein the computer system comprises means for calculating an expected time of delivery of said shipment.
